(19) United States
(12) Patent Application Publication
(10) Pub. No.: US 2016/0091902 A1
(43) Pub. Date: Mar. 31, 2016

(54) CONTROL SYSTEM

(71) Applicant: Azbil Corporation, Tokyo (JP)

(72) Inventor: Makoto KIKUCHI, Tokyo (JP)

(21) Appl. No.: 14/865,918

(22) Filed: Sep. 25, 2015

(30) Foreign Application Priority Data
Sep. 29, 2014 (JP) 2014-199040

(51) Int. Cl. G05D 23/13; G05B 19/048; G05B 19/10; G07C 9/00

(52) U.S. Cl. CPC G05D 23/1393; G07C 9/00126; G05B 19/048; G05B 19/10; G05B 2219/2614

(57) ABSTRACT

An entry thermopile placed outside a section and is used to acquire information about the spatial temperature distribution of a user who is using the section. A plurality of in-room thermopiles are placed respectively in a plurality of areas which virtually divide the space inside the section and obtain information about the spatial temperature distribution of the respective plurality of areas. An area specification unit is used to determine whether the spatial temperature distribution information of a user matches the spatial temperature distribution information of an area and specifies the area in the spatial temperature distribution information which has been determined as the location where the user is present by means of the in-room thermopiles.

### CROSS-REFERENCE TO RELATED APPLICATION

This application claims the benefit of and priority to Japanese Patent Application No. 2014-199040, filed on Sep. 29, 2014, the entire contents of which are incorporated by reference herein.

### TECHNICAL FIELD

The present invention relates to a control system and particularly to a control system that specifies the current position within a section of a user who enters a section of a facility and that carries out the optimum device control for the current location specified.

### TECHNICAL BACKGROUND

Prior art systems include an illumination device (see, for example, Patent Document 1) which detects the presence of a human, if any, using an infrared ray detection element (thermal type detection element) known as a thermopile and controls the ON/OFF for the illumination based on the detection results and an air-conditioning control system which controls the air-conditioning (see, for example Patent Document 2).

The lighting device in Patent Document 1 makes use of a characteristic in that changes in illuminance and thermal shift occur simultaneously only when people are moving around inside a room and is provided with an illuminance detection unit that outputs a high voltage when the ambient illuminance is high and a low voltage when the ambient illuminance is low as well as a human detection unit wherein the output value is H (high) when a human is not detected and the output value is L (low) when a human is detected.

As a result, the lighting device in Patent Document 1 reliably senses the presence of a human inside the room by AND processing of the output value of the illuminance detection unit and the human detection unit, thereby making it possible to control ON and OFF for the illumination.

In addition, the air-conditioning control system in Patent Document 2 is such that if there is an increase/decrease only in a value indicating any one piece of environmental datum in keeping with the presence of a human based on the temperature of the air inside a specific space, the CO₂ concentration and all of the environmental data for the electric energy consumed, then the set temperature is changed temporarily in accordance with the direction of the increase/decrease of the value indicated by the environmental data that generated the increase/decline.

With this air-conditioning control system, when there is an increase/decrease in the value indicated by two or more pieces of environmental data in accordance with the presence of a human, the set temperature is temporarily changed (raised or lowered) based on the priority sequence (air temperature>CO₂ concentration>amount of electric energy consumed) provided beforehand in each piece of environmental data.

### PRIOR ART LITERATURE

### Patent Documents

[Patent Document 1] Official Gazette of Patent Kokai 2013-093103
[Patent Document 2] Official Gazette of Patent Kokai 2011-064416

### SUMMARY OF INVENTION

### Problems the Present Invention is Intended to Solve

Incidentally, in the above mentioned Patent Document 1 and Patent Document 2, both inventions use a thermopile to make it possible to determine the presence or absence of a human as well as the number of humans for each space. However, there is a problem in that a thermopile cannot specify accurately where a person is located.

It is an objective of the present invention to solve this problem and to provide a control system that can accurately specify whether a person is present and where that person is located.

### Means Used to Solve the Problem

In order to attain this objective, the present invention is provided with a first acquisition unit (3) placed outside section (S) and used to obtain information on the spatial temperature distribution of the user (USR) using the above mentioned section (S); second acquisition units 7-1-7-50) placed respectively in a plurality of areas which virtually divide the space inside said section (S) and are used to obtain information on the distribution of the respective spatial temperatures of the plurality of areas; and an area specifying unit (52) used to determine information concerning the spatial temperature distribution of an area that is consistent with information on the spatial temperature distribution of a user (USR) from the information concerning said spatial temperature distribution for each of the abovementioned plurality of areas obtained by said second acquisition units (7-1-7-50) and which specifies said area for the information concerning the spatial temperature distribution that has been determined as the place where said user (USR) is located.

The present invention is further provided with a device control unit (6) used to control devices (8, 9) which are coordinated with the above mentioned area in response to the above mentioned area specified by said area specification unit (52) being specified as the location of said user (USR).

The present invention is further provided with a read unit (42) used to read the characteristics of said user (USR) from a database (41); said devices (8, 9) are air-conditioners (8) and said device control unit (6) is such that it controls said air-conditioners (8) according to the characteristics of said user (USR).

In the present invention, said devices (8, 9) are illumination fixtures (9); said device control unit (6) is such that it controls said illumination fixture (9) according to the characteristics of said user (USR).

The present invention is further provided with a room entry control unit (4) located outside said section (S) and used to determine whether or not said user (USR) is authorized to enter said section (S) through a verification request device (2) set up at the entrance.

### Effects of the Invention

The present invention makes it possible to accurately specify where a user (USR) is currently located by determining temperature distribution information for each area that coincides with the spatial temperature distribution information of the user (USR).

Based on the present invention, it is possible to accurately specify where a user (USR) is located so that a pleasant space can be provided for the user (USR) by controlling individually the devices (8, 9) corresponding to the area where the user (USR) is located.

Based on the present invention, it is possible to provide a pleasant space for the user (USR) by optimally controlling air-conditioners (8) according to the characteristics of the user (USR).

Based on the present invention, it is possible to provide a pleasant space for the user (USR) by optimally controlling illumination fixtures (9) according to the characteristics of the user (USR).

Based on the present invention, it possible to determine whether a user (USR) is authorized to enter a section (S) using a verification request device (2) set up outside the section and at the entrance so that it prevents infiltration of a section (S) to those other than an authorized user (USR) and at the same time prevents needless specification of the current position for persons other than an authorized user (USR).

### BRIEF EXPLANATION OF FIGURES

FIG. 1 is a block diagram of the overall configuration of the control system in an embodiment of the present invention.

FIG. 2 is a diagram indicating how the in-room thermopile group is set up in in an embodiment of the present invention.

FIG. 3 is a block diagram of the configuration of the check request device in an embodiment of the present invention.

FIG. 4 is a block diagram of the configuration of the room entry/exit control device in an embodiment of the present invention.

FIG. 5 is a block diagram of the configuration of the user specification device in an embodiment of the present invention.

FIG. 6 is a block diagram of the configuration of the device control apparatus in an embodiment of the present invention.

FIG. 7 is a diagram of the configuration of the device information database in an embodiment of the present invention.

FIG. 8 is a flowchart that explains the check request processing in an embodiment of the present invention.

FIG. 9 is a flowchart that explains the room entry/exit control processing in an embodiment of the present invention.

FIG. 10 is a flowchart that explains the user specification processing in an embodiment of the present invention.

FIG. 11 is a flowchart that explains the device control processing in an embodiment of the present invention.

### EMBODIMENTS OF THE INVENTION

Next we shall describe an embodiment of the invention while referring to the figures.

<Overview of Control System>

The control system in the embodiment of the present invention is what makes it possible to control individually the air-conditioner and illumination fixtures and other devices associated with the current position of the user by specifying who the user is and in what area inside the section the user is located when a user enters a room in a section (interior space) located in a facility. Next, we will describe the overall configuration of this control system.

<Overall Configuration of Control System>

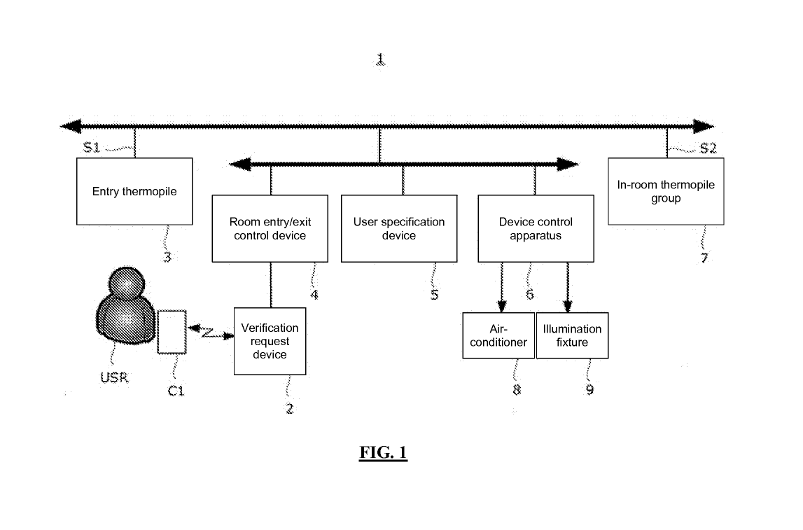

As shown in FIG. 1 and FIG. 2, in control system 1, verification request device 2, which is placed near the outside of door Dr placed on the surface of the wall of section s verifies the USR; entry thermopile 3 which is placed on the ceiling near verification request device 2 obtains a thermal image of user USR; room entry/exit control device 4 controls the locking or the unlocking of the door Dr based on the results of verification using verification request device 2; thermopiles in in-room thermopile group 7 are placed at equal intervals on the ceiling inside section s and the group is made up of in-room thermopiles 7-1-7-50 which obtain a thermal image for each of the areas virtually divided inside section s; user specification device 5 used to specify the current position of user USR present inside section s based on both thermal images acquired respectively using entry thermopile 3 and in-room thermopile group 7; and device control apparatus 6 used to control air-conditioners 8 and illumination fixtures 9 and other devices corresponding to the current position of the user USR specified by user specification device 5 are all connected via a network.

Here, the thermal image consists of information that represents the spatial temperature distribution (“temperature distribution information”) and is obtained respectively by entry thermopile 3 as the first acquisition unit and in-room thermopiles 7-1-7-50 as the second acquisition unit.

<Entry Thermopile>

Entry thermopile 3 consists of an infrared ray detection sensor (thermal type detection element) used for contact-free, two-dimensional detection of the thermal image of a user USR who is to be detected and is set up on the ceiling near verification request device 2. A thermopile array sensor, for example, may be used as entrance thermopile 3.

The thermopile array sensors receive infrared rays radiated from a human and are positioned in an array (grid pattern) on a thermopile detection element, for example, a semiconductor substrate that produces a thermal electromotive force corresponding to the amount of radiated energy. By using these thermopile array sensors, it becomes possible to collectively detect, the temperature distributions corresponding to a space with a predetermined range.

As a result, entrance thermopile 3 acquires thermal image S1 (“entrance side thermal image S1”) of user USR standing in front of verification request device 2 while user USR is carrying out the verification process by means of verification request device 2 using an ID card C1 and outputs this to room entry/exit control device 4 via a network.

<In-Room Thermopile Group>

In-room thermopile group 7 (FIG. 2) consists of a plurality of in-room thermopiles 7-1-7-50, which are placed at equal intervals on the ceiling inside section s. The respective in-room thermopiles 7-1-7-50 are infrared ray detection sensors having the same configuration as the abovementioned entrance thermopile 3.

These in-room thermopiles 7-1-7-50 are placed, respectively, in a plurality of areas so that they virtually and equally divide the space inside section s. The plurality of areas is such that the width of each area is determined based on the angle of visibility unique to the thermopile and a thermal image (“interior thermal image”) S2₁₋₇₀ representing information on the spatial temperature distribution between the bottom space of each area inside section s can be obtained by means of the in-room thermopiles 7-1-7-50.

<Verification Request Device>

Verification request device 2 comprises, for example, a card reader and when ID card C1 possessed by specific user USR who is entering a room from door Dr of section s is held over the card antenna, it reads the user ID that identifies the specific user USR from ID card C1; verification device 2 has a function in which room entry/exit control device 4 of this.

In addition, verification request device 2 has a function that notifies room entry/exit control device 4 of the unique device identification information allotted to the verification request device 2 together with the user USR user ID.

Furthermore, verification request device 2 is not necessarily limited to a contact-free card reader that reads the user ID without contact from ID card C1 and may be a contact-type card reader that reads the user ID when ID card C1 is inserted in the card slot. It is also possible to use a verification request device that uses the user USR fingerprints, pulse, iris and other biological information.

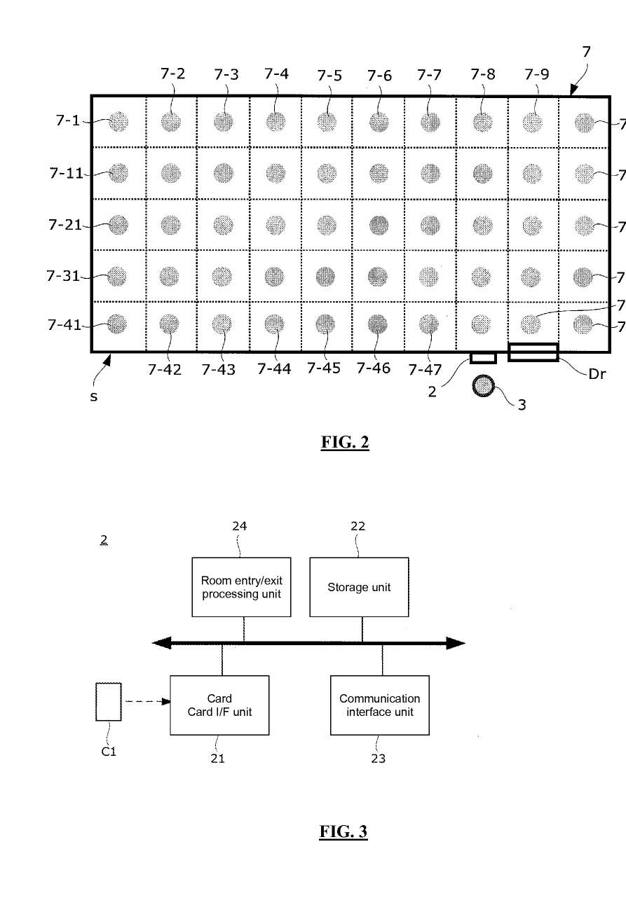

As shown in FIG. 3, verification request device 2 is provided with a room entry/exit processing unit 24 and the like that monitors room entry/exit by user USR for card interface unit 21, storage unit 22, communication interface unit 23 and section s.

Card interface unit 21 is comprises a dedicated interface circuit that includes a card antenna and has a function whereby a user ID used to identify the user USR who enters and exits the room in this section s in accordance with the user USR card operation using ID card C1 is read from ID card C1 without any contact.

Storage unit 22 is configured of storage devices such as semiconductor memory and a hard drive and stores such information as the user IDs for section s where the verification request device is set up, information identifying devices unique to verification request device 2, and user IDs read from ID card C1 via card interface unit 21.

Room entry/exit processing unit 24 generates a verification request for entry/exit authorization that includes the ID read via card interface unit 21, section ID which is stored in storage unit 22, and device identification information unique to check request device 2 and has a function that sends this to room entry/exit control device 4 via communication interface unit 23. Furthermore, room entry/exit processing unit 24 is implemented the CPU (central processing unit) reading a program.

Communication interface unit 23 receives data between verification request device 2 and the upper level of room entry/exit control device 4, sends a verification request to determine the abovementioned room entry/exit authorization to room entry/exit control device 4, and receives the results of determining room entry/exit authorization from this room entry/exit control device 4. The determination results (not shown in figure) of this room entry/exit authorization determination are displayed on a display device.

Here, ID card C1 comprises a memory card and an IC card and other mobile information processing card storage media and stores unique specific user IDs as information required to determine room entry/exist authorization to a user USR in possession of this ID card C1.

<Room Entry/Exit Control Device>

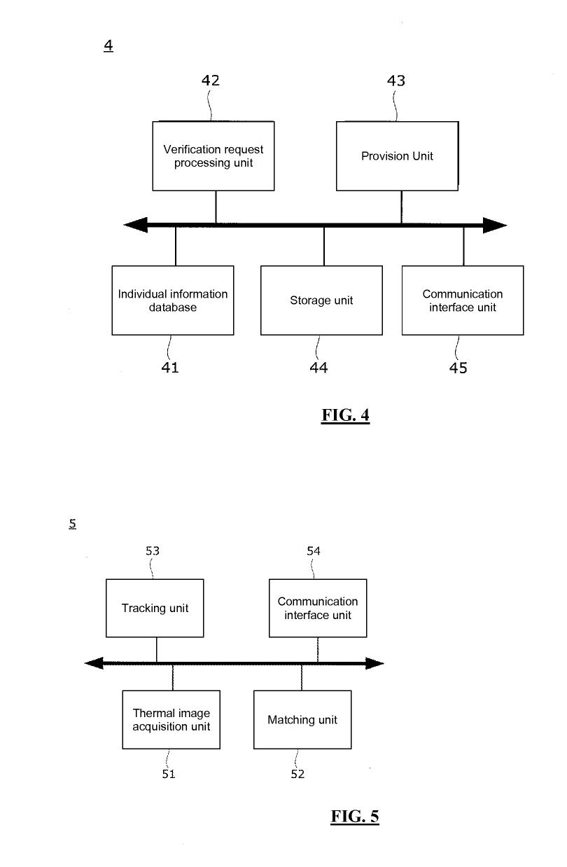

As shown in FIG. 4, room entry/exit control device 4 is provided with personal information database 41, verification request processing unit 42, provision unit 43, storage unit 44, and communication interface unit 45.

Individual information database 41 is a database that stores personal information related to a user USR who uses section s. Specifically, the name of the user USR, telephone number, e-mail address, authorized section ID and specific information indicating the authorization section ID and user USR characteristics (for example, sensitivity to heat, sensitivity to cold) and information on personal tastes (for example, a preference for bright lights, a preference for low lights and the like) are registered. Of these, the section authorization ID is an ID that indicates sections for which entry and exit by user USR is authorized.

Verification request processing unit 42 is provided with a function that acquires authorization section ID for a user USR from among personal information registered in personal information database 41 corresponding to the verification request of user USR received from verification request device 2 via communication interface unit 45; a function that verifies the authorized section ID and the section ID contained in the verification request from verification request device 2 and determines the room entry/exit authorization for user USR in this section s; and a function that unlocks an electric key for door Dr of section s in accordance with the determination results for room entry/exit authorization.

Provision unit 43 is provided with a function that identifies entrance side thermal image S1 received from entrance thermopile 3 of any section s based on device identification information of verification request device 2 contained in the verification request from verification request device 2 and a function that authorizes a user ID for user USR contained in the verification request from verification request device 2 for entrance side thermal image S1. As a result, room entry/exit control device 4 can associate a user USR user ID with the entrance side thermal image S1 for the section s.

Storage unit 44 has a function that stores the results for determining room entry/exit permission for a user USR and the unlocking history as well as the entrance side thermal image S1 for which a user USR user ID has been provided.

Communication interface unit 45 is provided with a function that sends the results of determining room entry/exit authorization by verification request processing unit 42 to verification request device 2, a function that sends user USR entrance side thermal image S1 that has provided a user ID by means of provision unit 43 to user specification device 5, and a function whereby specific information representing characteristics of the user USR read from individual information database 41 by verification request processing unit 42 and information on personal tastes are sent to device control device 6.

Furthermore, individual information database 41 and storage unit 44 are configured from a semiconductor memory and hard disk device and other storage devices; and verification request processing unit 42 and providing unit 43 are implemented by the CPU reading and executing a program.

<User Specification Device>

As shown in FIG. 5, user specification device 5 is provided with a thermal image acquisition unit 51, a matching unit 52, a tracking unit 53, and a communication interface unit 54.

Thermal image acquisition unit 51 is provided with a function that acquires user USR entrance side thermal image S1 sent from room entry/exit control device 4 via a network and a function that acquires inside thermal images S2₁₋₇₀ of each area that are sent from in-room thermopiles 7-1-7-50 of in-room thermopile group 7 via the respective networks.

Matching unit 52 is provided with a function that determines whether entrance side thermal image S1 of user USR acquired by thermal image acquisition unit 51 coincides with inside thermal images S2₁₋₇₀ in each of the sections s based on the brightness in pixel units. Here, matching between entrance side thermal image S1 and inside thermal images S2₁₋₇₀ is carried out by using a commonly known pattern matching method.

As a result, when matching unit 52 finds that entrance side thermal image S1 of user USR and any of inside thermal images S2₁₋₇₀ in the respective areas in the inside space of section s match, the area is specified by the numbers of the coinciding in-room thermopiles 7-1-7-50 (“in-room thermopile number”). As a result, matching unit 52 can recognize the current position of the user USR inside section s by the in-room thermopile numbers that are the specific results.

Tracking unit 53 is provided with a function that tracks the time series variation of a specific area (“matching area”) specified by matching unit 52.

In other words, tracking unit 53 always knows the current position of a user USR in the inside space of section s by tracking the matching areas and sends the in-room thermopile number indicating the current position (area) of user USR to device control apparatus 6 via the network using communication interface unit 55.

Communication interface unit 54 is provided with a function that sends the matching results (matching results or non-matching results) using matching unit 52 to device control apparatus 6 via a network and a function that notifies device control device 6 via a network of the in-room thermopile number that specifies the present position of the user when matching results are obtained.

Furthermore, thermal image acquisition unit 51, matching unit 52, and tracking unit 53 are realized when the CPU reads and executes a program.

<Device Control Apparatus>

As shown in FIG. 6, device control apparatus 6 is provided with device information database 61, device control unit 62, storage unit 63, and communication interface unit 64.

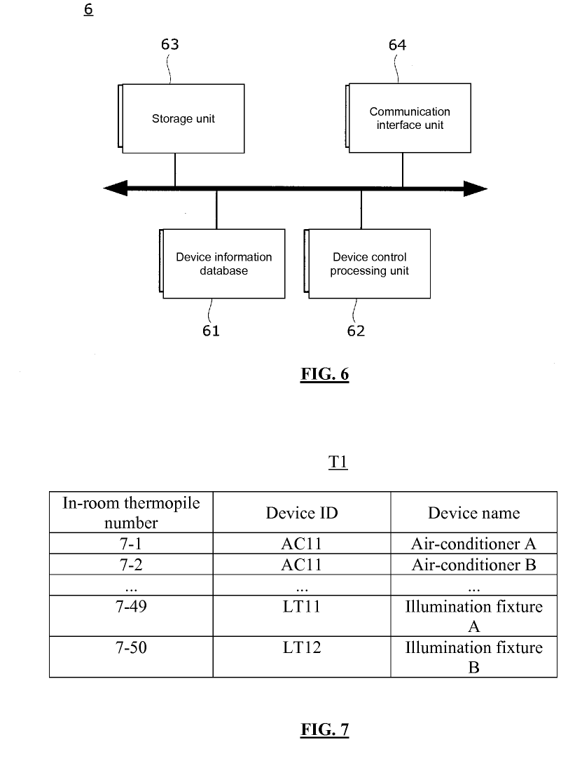

Device information database 61 is a database that records device information relating to air-conditioners 8 and illumination fixtures 9 that correspond to each area in the interior space of section s. As shown in FIG. 7, device information database 61 has a table T1 coordinated with the in-room thermopile numbers (7-1-7-50), device IDAC11-LT12, and device name (air-conditioner A through illumination fixture B).

This table T1 shows the device that is associated with each area in the in-room space of section s specified by in-room thermopile numbers (7-1-7-50) by showing the device ID and device name.

For example, a device with the device name “air-conditioner A” specified by device ID “AC11” is associated with the area in which in-room thermopile number 7-1 is placed. Likewise, a device with the device name “air-conditioner B” specified by device ID “AC12” is associated with the area in which in-room thermopile numbers 7-2 is placed. In this way, for all the areas of the interior space of section s, the in-room thermophile number, device ID and device name are respectively registered in table T1.

Device control unit 62 is provided with a function that receives notification of an in-room thermophile number showing the current location of user USR form user specification device 5 via communication interface 64, refers to device information database 61, and identifies the device by specifying the device ID and device name associated with the in-room thermopile number based on Table T1 and a function that outputs a control instruction to control the operation of the device by means of communication interface unit 64.

Specifically, when device control unit 62 recognizes, for example, that the current position of the user USR is an area specified by in-room thermopile number 7-1, it outputs control instructions to operate air-conditioner A with device ID “AC11.”

Then, when device control unit 62 recognizes that the current position of the user USR who has been tracked by tracking unit 53 of user specification device 5 has, for example, moved to an area specified by in-room thermopile number 7-2 from an area specified by in-room thermopile number 7-1, it outputs control instructions to operate air-conditioner B with device ID “AC12.”

Furthermore, at this time device control unit 62 also outputs control instructions to stop air-conditioner A with device ID “AC11” since user USR is no longer present in an area specified by in-room thermopile number 7-1.

Communication interface unit 64 has a function that receives specific information indicating the characteristics and the personal preferences of user USR sent from room entry/exit control device 4 and outputs these to storage unit 63.

Storage unit 63 has a function that stores the operating history of a device controlled by device control unit 62 and stores characteristic information (for example, sensitivity to heat, sensitivity to cold) and information on personal preferences (for example, whether user likes bright light or prefers subdued lighting and the like) that indicates the characteristics of the user USR sent from room entry/exit control device 4.

<Operations in the Control System>

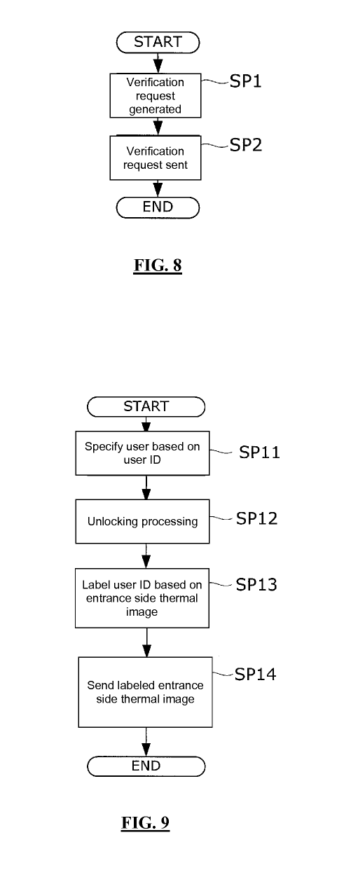

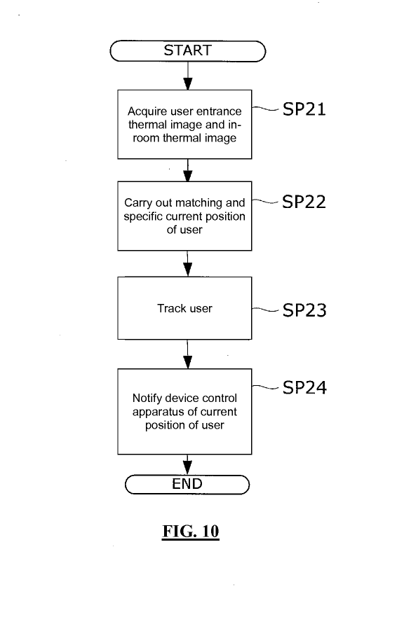

Next, we will use the flowcharts in FIG. 8 through FIG. 11 to provide an explanation of a series of operations in control system 1 that perform identification by verifying user USR using verification request device 2 and room entry/exit control device 4, specify where user USR is located in the interior space of section s using user specification device 5, and control the device associated with the specified areas.

As shown in FIG. 8, verification request device 2 of control system 1 generates a request for verification based on the user ID, etc., read from ID card C1 of user USR (Step SP1), sends this to room entry/exit control device 4 using communication interface unit 23 (Step SP2) and completes verification request processing.

As shown in FIG. 9, room entry/exit control device 4 of control system 1 identifies user USR based on the user ID contained in the verification request received from verification request device 2 (Step SP11). At the same time, room entry/exit control device 4 specifies that this verification request device 2 is located in section s based on the unique device identification information of verification device 2 contained in the verification request.

Room entry/exit control device 4 can identify user USR and section s so that is opens the electric lock of door Dr in this section s (Step SP12), provides the user ID for user USR for the entrance thermal image S1 obtained by entrance thermopile 3 of this section s (Step SP13), then sends the entrance side thermal image S1 of user USR provided by this user ID to user specification device 5 (Step SP14) and completes the room entry/exit control processing.

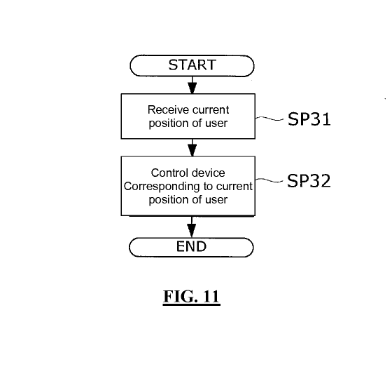

As shown in FIG. 10, user specification device 5 of control system 1 acquires entrance side thermal image S1 for user USR using thermal image acquisition unit 51 and inside thermal image S2₁₋₇₀ acquired in in-room thermopiles 7-1-7-50 (Step SP21).

Then, user specification device 5 sees whether entrance side thermal image S1 of user USR matches interior thermal image S2₁₋₇₀ and specifies the current position (area) where user USR is located by using the in-room thermopile number of matching in-room thermopiles 7-1-7-50 (Step SP22).

After that, user specification device 5 tracks the current position of user USR by monitoring the time series variations of the matching area using tracking unit 53 (Step SP23) and notifies device control device 6 of the in-room thermopile number which indicates the current position of user USR in the interior space of section s using communication interface unit 55 via a network (Step SP24).

As shown in FIG. 11, device control apparatus 6 of control system 1 receives the in-room thermopile number indicating the current position of user USR from user specification device 5 (Step SP31).

Next, device control device 6 recognizes the area indicating the current position of user USR in the interior space of section s using the in-room thermopile number, outputs control instructions for the specified device using the device ID and the device name associated with the in-room thermopile number by referencing table T1 of device information database 61, operates air-conditioner 8 or illumination fixture 9 associated with the area of the present position of user USR (Step SP32) and completes device control processing.

At this time, when air-conditioner 8 or illumination fixture 9 associated with the area of the current position of user USR is operated, the device can be operated separately in accordance with the specific information and personal preference information shown in the characteristics of user USR.

When device control unit 62 of device control apparatus 6 reads specific information indicating sensitivity to heat as a characteristic of a user USR and when air-conditioner 8 is operated, a control instruction can be output to set the temperature one degree lower than the default set temperature.

Meanwhile, when device control unit 62 of device control apparatus 6 reads specific information indicating sensitivity to cold as a characteristic of user USR from storage unit 63 and when air-conditioner 8 is operated, control instructions can be output to make the temperature one degree above the default set temperature.

Additionally, when device control unit 62 of device control apparatus 6 reads information on personal preferences indicating a preference for bright lights as a characteristic of user USR from storage unit 63, control instructions to light up all the illumination fixtures 9 can be output.

Meanwhile, when device control unit 62 of device control apparatus 6 reads information on a personal preference for low lights as a characteristic of user USR from storage unit 63, it is possible to output control instructions to light up only part of the illumination fixtures 9.

Furthermore, device control unit 62 does not control the number of individual illumination fixtures 9 and when there is only one illumination fixture 9, the brightness of illumination fixture 9 can be controlled.

<Effects>

In this way, control system 1 acquires entrance side thermal image S1 of user USR at a verification point before entering the interior space of section s and by means of room entry/exit control device 4 providing the user USR user ID to entrance side thermal image S1 can identify a user USR entering the interior space of section s using entrance side thermal image S1 that has been provided with the user ID.

In addition, by means of user specification device 5, it is possible to accurately identify the current location (area) of user USR who has entered the interior space of section s by means of an in-room thermopile number by matching interior thermal images S2₁₋₇₀ acquired by inside thermopiles 7-1-7-50.

As a result, device control apparatus 6 identifies the current position (area) of user USR accurately using an in-room thermopile number and does not operate a device associated in advance with that in-room thermopile number and so can control the operating state of the devices individually while taking into consideration the specific information and the information on personal preferences showing the characteristics of user USR.

With control system 1, even when user USR is present in various interior spaces of section s, a pleasant space can be provided automatically for user USR in the area of his/her current location.

### Other Embodiments

Furthermore, in the abovementioned embodiment, we discussed using the thermopile array sensors as an infrared ray detection sensor (thermal type detection element). However, it should by no means be construed that the present invention is limited to this and a bolometer, pyroelectric element, or other thermal type detection elements may be used.

In addition, in the above embodiment, we discussed accurately identifying the current position of user USR using an in-room thermopile number and controlling individually the operations of devices associated with the specified area using the in-room thermopile number in accordance with the characteristic information and personal preference information indicating the characteristics of the user.

However, it should by no means be construed that the present invention is limited to this and of each of the areas in the interior space of section s, a single area set beforehand for the user USR is registered in individual information database 41 of room entry/exit control device 4 as the home position and the home position information may be sent from room entry/exit control device 4 to device control apparatus 6. As a result, when the current position of user USR is the area of the home position, device control unit 62 of device control apparatus 6 can operate air-conditioner 8 and illumination fixture 9 using the specifications set by user USR beforehand.

In addition, in the above mentioned embodiment, we discussed the brightness level of the entrance side thermal image S1 and the inside thermal image S2 being matched in pixel units by matching unit 52 of user specification device 5. However, it should by no means be construed that the present invention is limited to these and matching can be carried out by template matching and a variety of other pattern matching methods using the characteristic points of an image.

Also, in the above mentioned embodiment, we provided an example in which air-conditioner 8 and illumination fixture 9 were devices to be controlled by device control apparatus 6. However, it should by no means be construed that the present invention is limited to these and personal computers and other electronic devices and other devices can be used as control target.

### EXPLANATION OF SYMBOLS

1 . . . control system,
2 . . . verification request device,
3 . . . entrance thermopile (first acquisition unit),
4 . . . room entry/exit control device (room entry control unit),
5 . . . user specification device,
6 . . . device control apparatus (device control unit),
7 . . . in-room thermopile group, 7-1-7-50 . . . in-room thermopiles (second acquisition unit),
8 . . . air-conditioner (device),
9 . . . illumination fixture (device),
21 . . . card I/F unit,
22 . . . storage unit,
23 . . . communication interface unit,
24 . . . room entry/exit processing unit,
41 . . . individual information database,
42 . . . verification request processing unit,
43 . . . provision unit,
44 . . . storage unit (storage unit),
45 . . . communication interface unit,
51 . . . thermal image acquisition unit,
52 . . . matching unit (area specification unit),
53 . . . tracking unit,
54 . . . communication interface unit,
61 . . . device information database,
62 . . . device control processing unit,
63 . . . storage unit,
64 . . . communication interface unit, S . . . partition, C1 . . . ID card, USR . . . user,

1. A control system comprising:
a first acquisition unit disposed outside a section and configured to acquire information on a spatial temperature distribution of a user who uses the above-mentioned section;
a plurality of second acquisition units disposed respectively in a plurality of areas that virtually divide a space that is located inside the section, the plurality of second acquisition units configured to acquire spatial temperature distribution information on the respective plurality of areas; and
an area specification unit configured to determine whether spatial temperature distribution information for an area is consistent with spatial temperature distribution information of the user from spatial temperature distribution information for each area of the plurality of areas acquired by the respective plurality of second acquisition units, the area specification unit configured to specify a user area in the spatial temperature distribution information determined as a location of the user.

2. The control system of claim 1, further comprising a device control unit configured to control devices corresponding to the user area in response to specifying the user area by the area specification unit as a location where the user is located.

3. The control system of claim 2, further comprising a read unit configured to read characteristics of the user from a database;
wherein the a device corresponding to the user is an air-conditioner;
and wherein the device control unit is configured to control the air-conditioner in accordance with the characteristics of the user.

4. The control system of claim 3, wherein a device corresponding to the user is an illumination fixture;
and wherein the device control unit is configured to control the illumination fixture in accordance with the characteristics of the user.

5. The control system of claim 1, further comprising a room entry control unit disposed outside the section, the room entry control unit is configured to determine whether the user is authorized to enter the section via a verification device disposed at an entrance of the section.
